(19) United States
(12) Patent Application Publication
(10) Pub. No.: US 2026/0210110 A1
(43) Pub. Date: Jul. 23, 2026

(54) DOUBLE-SIDED COMPOSITE REINFORCED ROCKWOOL BOARD, PRODUCTION EQUIPMENT, AND PREPARATION METHOD

(71) Applicant: Owens Corning Intellectual Capital, LLC, Toledo, OH (US)

(72) Inventors: Haipo Wang, Shanghai (CN); Yang Li, Shanghai (CN); Chunming Shi, Shanghai (CN)

(21) Appl. No.: 19/140,588

(22) PCT Filed: Aug. 14, 2024
(86) PCT No.: PCT/US2024/042203

§ 371 Date: Jun. 18, 2025

(30) Foreign Application Priority Data
Sep. 8, 2023 (CN) 202311161536.7

(51) Int. Cl. E04B 1/80; B32B 5/02; B32B 19/06; D03D 15/267; D04H 1/4218; D04H 1/4382; D06N 3/00; D06N 3/04

(52) U.S. Cl. CPC E04B 1/80; B32B 5/022; B32B 5/024; B32B 19/06; D03D 15/267; D04H 1/4218; D04H 1/43835; D06N 3/0011; D06N 3/0022; D06N 3/0063; D06N 3/042; B32B 2255/02; B32B 2255/26; B32B 2260/021; B32B 2260/046; B32B 2262/101; B32B 2307/718; B32B 2307/7375; D10B 2401/063; D10B 2505/02

(57) ABSTRACT

The present disclosure provides a double-sided composite reinforced rockwool board, a production equipment, and a preparation method. The double-sided composite reinforced rockwool board has a length ranging from 600 mm to 2400 mm, a width ranging from 600 mm to 2400 mm, and a thickness ranging from 20 mm to 200 mm. The double-sided composite reinforced rockwool board comprises a rockwool base layer and two reinforced surface layers. The two reinforced surface layers are respectively bonded by a binder to two opposite surfaces of the rockwool base layer along a thickness direction. The 90° peel strength between any one of the two reinforced surface layers and the rockwool base layer ranges from 4N/75 mm to 30N/75 mm. By bonding the reinforced surface layer to the two surfaces of the rockwool base layer along the thickness direction through the binder, the double-sided composite reinforced rockwool board of the present disclosure is conducive to increasing the strength of the two surfaces of the rockwool base layer outwards along the thickness direction, thereby preventing the corresponding surfaces of the rockwool base layer from being damaged by friction in the process of transportation and construction, and improving the overall service life of the board.

### CROSS-REFERENCE TO RELATED APPLICATION(S)

This application claims priority to Chinese Patent Application No. 202311161536.7 filed on Sep. 8, 2023, the disclosure of which is incorporated by reference herein in its entirety.

### BACKGROUND

The present disclosure generally relates to the technical field of building materials, and more particularly to a double-sided composite reinforced rockwool board, a production equipment, and a preparation method.

In a roofing system with related technologies, rockwool boards are usually laid. However, the rockwool board is easy to drop dust due to friction in the process of transportation and construction because of the poor surface friction performance. This not only causes damage to the roofing system, but also makes it difficult to construct and transport.

Therefore, it is necessary to provide a double-sided composite reinforced rockwool board, a production equipment, and a preparation method to at least partially solve the above problem.

### SUMMARY

A series of simplified concepts is introduced into the portion of SUMMARY, which would be further illustrated in the portion of the DETAILED DESCRIPTION. The SUMMARY of the present disclosure does not mean attempting to define the key feature and essential technical feature of the claimed technical solution, let alone determining the protection scope thereof.

To at least partially solve the problem, the first aspect of the present disclosure provides a double-sided composite reinforced rockwool board, wherein the double-sided composite reinforced rockwool board has a length ranging from 600 mm to 2400 mm, a width ranging from 600 mm to 2400 mm, and a thickness ranging from 20 mm to 200 mm, and the double-sided composite reinforced rockwool board comprises: a rockwool base layer; and two reinforced surface layers respectively bonded by a binder to two opposite surfaces of the rockwool base layer along a thickness direction, the 90° peel strength between any one of the two reinforced surface layers and the rockwool base layer ranging from 4 N/75 mm to 30 N/75 mm.

By bonding the reinforced surface layer to the two surfaces of the rockwool base layer along the thickness direction through the binder, the double-sided composite reinforced rockwool board according to the first aspect of the present disclosure is conducive to increasing the strength of the two surfaces of the rockwool base layer outwards along the thickness direction, thereby preventing the corresponding surfaces of the rockwool base layer from being damaged by friction in the process of transportation and construction, and improving the overall service life of the board. By setting the 90° peel strength of the reinforcing surface layer and the rockwool base layer in the range of 4 N/75 mm to 30 N/75 mm, the robustness of the connection structure between the reinforcing surface layer and the rockwool base layer is ensured.

Optionally, the reinforced surface layer is configured as at least one of glass fiber woven fabric, coated non-woven felt, and non-coated non-woven felt.

Optionally, the reinforced surface layer is configured as glass fiber woven fabric, wherein, the glass fiber woven fabric is knitted plain cloth with a gram weight ranging from 40 g/m² to 1200 g/m²; or the glass fiber woven fabric is mesh cloth with a gram weight ranging from 40 g/m² to 200 g/m².

Optionally, the reinforced surface layer is configured as coated non-woven felt, wherein, the coated non-woven felt has a gram weight ranging from 100 g/m² to 400 g/m²; and/or the coated non-woven felt has a thickness ranging from 0.1 mm to 1.5 mm; and/or the coated non-woven felt has a tensile strength ranging from 100 N/50 mm to 1000 N/50 mm; and/or the coated non-woven felt has a calorific value ranging from 1 MJ/kg to 10 MJ/kg; and/or the coated non-woven felt has an air permeability under 100 Pa pressure ranging from 100 L/m²·s to 10000 L/m²·s; and/or the coated non-woven felt after aging has a strength retention rate ranging from 50% to 100%.

Optionally, the reinforced surface layer is configured as coated non-woven felt, a coating of which is made of resin and filler; the resin is configured as acrylic resin, and the filler is made of calcium carbonate, cement, sand and color master.

Optionally, the coated non-woven felt is configured as coated non-woven glass fiber felt.

Optionally, the reinforced surface layer is configured as non-coated non-woven felt, wherein, the non-coated non-woven felt has a gram weight ranging from 30 g/m² to 100 g/m²; and/or the non-coated non-woven felt has a thickness ranging from 0.1 mm to 1.0 mm; and/or the non-coated non-woven felt has a tensile strength ranging from 100 N/50 mm to 1000 N/50 mm; and/or the non-coated non-woven felt has a calorific value ranging from 1 MJ/kg to 10 MJ/kg; and/or the non-coated non-woven felt after aging has a strength retention rate ranging from 50% to 100%.

Optionally, the reinforced surface layer is configured as non-coated non-woven felt, wherein, the non-coated non-woven felt is made of glass fiber and urea-formaldehyde resin; or the non-coated non-woven felt is made of glass fiber and acrylic resin.

Optionally, the non-coated non-woven felt is configured as non-coated non-woven glass fiber felt.

Optionally, the double-sided composite reinforced rockwool board has a density ranging from 60 kg/m³ to 220 kg/m³.

Optionally, a resin bonding the rockwool base layer and either of the two reinforced surface layers has a weight ranging from 1 g/m² to 100 g/m²; or a binder bonding the rockwool base layer and the two reinforced surface layers has a weight ranging from 1 g/m² to 100 g/m².

Optionally, the binder is made of at least one of phenolic resin, epoxy resin, polyurethane, acrylic resin, sugar-based resin, urea-formaldehyde resin and polyvinyl alcohol resin.

Optionally, the rockwool base layer is configured as a structure pressed by using a pleating process, a pleating ratio ranges from 1.0 to 4.0.

Optionally, the rockwool base layer has resin, and a resin content of the rockwool base layer ranges from 1.0% to 5.0%.

The second aspect of the present disclosure provides a production equipment for a double-sided composite reinforced rockwool board, which is used for producing the double-sided composite reinforced rockwool board, wherein the production equipment for the double-sided composite reinforced rockwool board comprises: a transfer device for conveying rockwool base body; a first composite device arranged corresponding to an upper portion of the rockwool base body located on the transfer device, and configured to apply glue to the reinforced surface layer above the rockwool base body and convey the reinforced surface layer to the upper portion of the rockwool base body such that the reinforced surface layer is attached to the upper portion of the rockwool base body; and a second composite device arranged corresponding to a lower portion of the rockwool base body located on the transfer device, and configured to apply glue to the reinforced surface layer below the rockwool base body and convey the reinforced surface layer to the lower portion of the rockwool base body such that the reinforced surface layer is attached to the lower portion of the rockwool base body.

According to the production equipment for the double-sided composite reinforced rockwool board in the second aspect of the present disclosure, the rockwool base body is transported through the transfer device; the reinforced surface layer located above the rockwool base body is applied with glue and transported to the upper portion of the rockwool base body by the first composite device, such that the reinforced surface layer above the rockwool base body can be attached to the upper portion of the rockwool base body; the reinforced surface layer located below the rockwool base body is applied with glue and transported to the lower portion of the rockwool base body by the second composite device, such that the reinforced surface layer below the rockwool base body can be attached to the lower portion of the rockwool base body. By adopting the production equipment for the double-sided composite reinforced rockwool board of the present disclosure, the upper and lower portions of the rockwool base body can be attached to the reinforced surface layer, respectively, and the double-sided composite reinforced rockwool board can thereby be prepared; since the first composite device and the second composite device can operate simultaneously, it helps to improve the production efficiency of the double-sided composite reinforced rockwool board.

Optionally, the first composite device and the second composite device both comprise: an unwinding assembly configured to unwind a rolled reinforced surface layer; and a gluing assembly configured to apply a binder to the unwound reinforced surface layer.

Optionally, the production equipment for the double-sided composite reinforced rockwool board further comprises a curing furnace; the unwinding assembly and the gluing assembly of the second composite device both are located below the curing furnace, and the second composite device also includes a traction assembly, one end of which is arranged corresponding to an inlet of the curing furnace, such that the reinforced surface layer coated with the binder is close to a lower surface of the rockwool base body, and the other end of which is arranged corresponding to the gluing assembly to undertake the reinforced surface layer coated with the binder.

Optionally, the traction assembly comprises: a traction support; two synchronization shafts rotationally connected to the traction support about their own axes, wherein the two synchronization shafts are parallel to each other and cross a conveying direction of the rockwool base body, and the two synchronization shafts are disposed at intervals along a vertical direction; two pairs of sprockets, one pair of which is respectively disposed on two ends of one of the two synchronization shafts, and the other pair of which is respectively disposed on two ends of the other of the two synchronization shafts; a pair of chains disposed at intervals along axial directions of the synchronization shafts and engaged with the sprockets; and traction members with which the pair of chains are respectively provided, and arranged relative to each other in the pair of chains and used to connect to an end portion of a traction rope.

Optionally, the traction assembly further comprises: a cutting member located at an end portion of the traction support near an inlet of the curing furnace, and having a cutting part used for cutting off a traction rope, the cutting part being located in an interval region between a pair of the traction members.

Optionally, the unwinding assembly comprises a mandrel, a transverse movable support, a longitudinal movable support and a frame, the transverse movable support being movably connected to the frame along a transverse direction, the longitudinal movable support being movably connected to the transverse movable support along a longitudinal direction, and an end portion of the mandrel is connected to the longitudinal movable support and an outer part of the mandrel is used to sleeve the rolled reinforced surface layer.

Optionally, the unwinding assembly comprises a mandrel, a transverse movable support and a frame, the transverse movable support being movably connected to the frame along a transverse direction, and the mandrel being rotationally disposed about its own axis relative to the transverse movable support.

Optionally, the unwinding assembly comprises a mandrel, a longitudinal movable support and a frame, the longitudinal movable support being movably connected to the frame along a longitudinal direction, and the mandrel being rotationally disposed about its own axis relative to the longitudinal movable support.

Optionally, the unwinding assembly comprises at least two mandrels disposed at intervals along a conveying direction of the reinforced surface layer.

Optionally, the gluing assembly comprises a glue groove, a glue roller and a guide roller, the glue groove being used to accommodate a binder, the glue roller being at least partially located inside the glue groove and rotationally disposed about its own axis relative to the glue groove, the glue roller being used to apply the binder to the reinforced surface layer, the guide roller being rotationally disposed about its axis relative to the glue groove, and the glue roller and the guide roller being respectively used to contact two surfaces with different orientations of the reinforced surface layer.

Optionally, the gluing assembly comprises a pair of guide rollers respectively located on both sides of the glue roller along a conveying direction of the reinforced surface layer to limit a contact area between the glue roller and the reinforced surface layer.

Optionally, the guide roller is movably disposed along a vertical direction relative to the glue roller to adjust a contact area between the guide roller and the reinforced surface layer.

Optionally, the gluing assembly comprises a glue groove, an upper glue roller and a lower glue roller, the lower glue roller being at least partially located inside the glue groove and rotationally disposed about its own axis relative to the glue groove, the upper glue roller being located above the lower glue roller and being in contact with or close to a surface of the lower glue roller, the lower glue roller being used to adhere a binder in the glue groove to the upper glue roller, and the upper glue roller being used to apply the binder to the reinforced surface layer.

Optionally, the upper glue roller and the lower glue roller are movably disposed relative to each other along a vertical direction.

The third aspect of the present disclosure provides a preparation method for a double-sided composite reinforced rockwool board, which is used for producing the double-sided composite reinforced rockwool board, wherein the double-sided composite reinforced rockwool board preparation method comprises the following steps: S0, after making the rockwool fiber into fiber and applying glue, integrating the rockwool fiber is integrated into a primary felt through negative pressure adsorption by using a cotton collecting device and then evenly distributing the primary felt on a production line layer by layer via a pendulum, so as to obtain an uncured rockwool base layer; S1, uniformly applying a binder on a surface of the reinforced surface layer; S2, respectively bonding online the two reinforced surface layers to two opposite surfaces of the uncured rockwool base layer along a thickness direction by using an online curing and drying process, and the bonded reinforced surface layers and the rockwool base layer passing through the curing furnace and being dried, cured and molded under the action of a ventilation air flow and a pressurization of a chain plate of the curing furnace, so as to obtain a double-sided double-sided composite reinforced rockwool board.

According to the preparation method for the double-sided composite reinforced rockwool board in the third aspect of the present disclosure, after a binder is applied to the reinforced surface layer, the two reinforced surface layers with the binder are respectively bonded to two opposite surfaces of the rockwool base layer along the thickness direction and then solidified by the curing furnace, and the double-sided composite reinforced rockwool board is prepared. By using the preparation method of the double-sided composite reinforced rockwool board of this disclosure, the double-sided composite reinforced rockwool board can be made, and the production efficiency can be improved.

Optionally, a process of applying the binder is one of spraying, coating and film transferring in step S1.

Optionally, in step S1, the binder is selected from at least one of phenolic resin, epoxy resin, polyurethane, acrylic resin, sugar-based resin, urea-formaldehyde resin, and polyvinyl alcohol resin.

Optionally, in step S2, the curing furnace has at least two temperature zones, and each temperature zone is successively disposed at a position from an inlet to an outlet of the curing furnace and has a temperature ranging from 180° C. to 300° C.

### BRIEF DESCRIPTION OF THE DRAWINGS

The following drawings are hereby incorporated as part of the present disclosure for the understanding of the present disclosure. The embodiments are illustrated and described in the drawings in order to explain the principles of the present disclosure. In the drawings:

FIG. 1 shows a block diagram of a production device of a double-sided composite reinforced rockwool board according to a preferred embodiment of the present disclosure;

FIG. 2 shows a structure diagram of a first composite device according to a preferred embodiment of the present disclosure;

FIG. 3 shows a structure diagram of connecting a second composite device to a curing furnace according to a preferred embodiment of the present disclosure;

FIG. 4 shows a structure diagram of a traction assembly according to a preferred embodiment of the present disclosure;

FIG. 5 shows a sectional view taken along line A-A in FIG. 4;

FIG. 6 shows an enlarged view at I in FIG. 5;

FIG. 7 shows an enlarged view at II in FIG. 5; and

FIG. 8 shows a schematic diagram of a composite reinforced rockwool board in a 90° peel strength test according to a preferred embodiment of the present disclosure.

EXPLANATION OF REFERENCE NUMERALS

| | |
|---|---|
| 100: Transfer device | 200: First composite device |
| 210: First unwinding assembly | 211: First mandrel |
| 212: First transverse movable support | 213: First transverse adjusting member |
| 214: First longitudinal movable support | 215: First longitudinal adjusting member |
| 216: First frame | 217: First brake member |
| 220: First gluing assembly | 221: First glue groove |
| 222: First glue roller | 223: First guide roller |
| 300: Second composite device | 310: Second unwinding assembly |
| 311: Second mandrel | 312: Second transverse movable support |
| 314: Second longitudinal movable support | 315: Second longitudinal adjusting member |
| 316: Second frame | 320: Second gluing assembly |
| 321: Second glue groove | 322: Second glue roller |
| 323: Second guide roller | 330: Traction assembly |
| 331: Traction support | 332: Synchronization shaft |
| 333: Sprocket | 334: Chain |
| 335: Traction member | 336: Cutting member |
| 336a: Cutting part | 337: Synchronization handwheel |
| 338: Adjusting handwheel | 400: Curing furnace |
| 400a: Inlet | 510: Rockwool base layer |
| 520: Reinforced surface layer | F: Tensile force |
| D1: Longitudinal direction | D2: Transverse direction |
| D3: Vertical direction | |

### DETAILED DESCRIPTION

In the following description, numerous specific details are set forth in order to provide a more thorough understanding of the present disclosure. However, it is obvious to those skilled in the art that embodiments of the present disclosure may be implemented without one or more of these details. Some technical features well-known in this art are not described in other examples in order to avoid confusion with the embodiments of the present disclosure.

In order to thoroughly understand the present disclosure, a detailed structure will be provided in the following description. Obviously, the embodiments of the present disclosure are not limited to the specific details familiar to those skilled in the art.

It is to be understood that the terminology used herein is for the purpose of describing particular embodiments only and is not intended to limit the present disclosure. The singular forms “a”, “an”, and “the” are intended to include the plural forms as well, unless the context clearly indicates otherwise. The terms “comprising” and/or “including”, when used in this specification, specify the presence of stated features, wholes, steps, operations, elements, and/or components, but do not preclude the presence or addition of one or more other features, wholes, steps, operations, elements, components, and/or combinations thereof.

Ordinals such as “first” and “second” referred in this disclosure are merely identifiers and do not carry any other meaning, such as a specific order. Moreover, for example, the term “first component” itself does not imply the presence of “second component”, and the term “second component” itself does not imply the presence of “first component”. It should be noted that the terms “up”, “down”, “front”, “back”, “left”, “right”, “inside”, “outside” and similar expressions used herein are for illustrative purposes only and are not restrictive.

Hereinafter, the exemplary embodiments of the present disclosure will be explained in further details with reference to the accompanying drawings, which show the representative embodiments of the disclosure and do not limit the present disclosure.

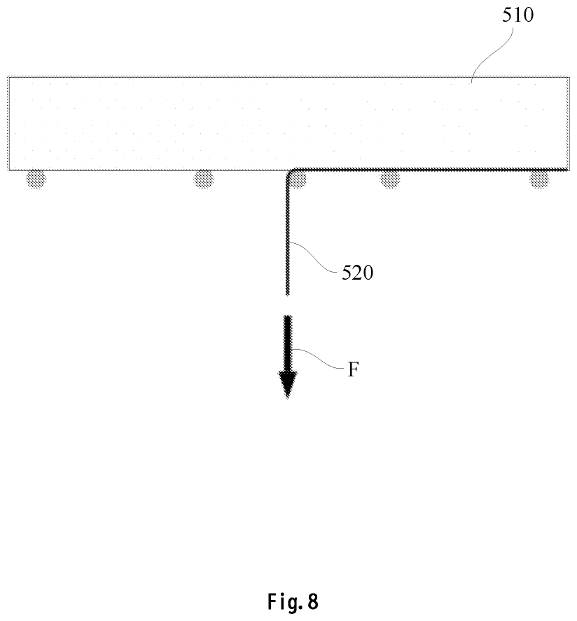

The present disclosure provides a double-sided composite reinforced rockwool board. The double-sided composite reinforced rockwool board according to the present disclosure has a length ranging from 600 mm to 2400 mm, a width ranging from 600 mm to 2400 mm, and a thickness ranging from 20 mm to 200 mm. The length of the double-sided composite reinforced rockwool board is greater than or equal to the width of the double-sided composite reinforced rockwool board. Referring to FIG. 8, the double-sided composite reinforced rockwool board according to present disclosure may comprise a rockwool base layer 510 and two reinforced surface layers 520 respectively bonded by a binder to two surfaces of the rockwool base layer 510, which are opposite along a thickness direction.

It is to be understood that the double-sided composite reinforced rockwool board according to present disclosure is a layered composite structure. When the double-sided composite reinforced rockwool board of present disclosure is placed in a horizontal attitude, the thickness direction of the double-sided composite reinforced rockwool board is parallel to the vertical direction.

By bonding the reinforced surface layer 520 to the two surfaces of the rockwool base layer 510 along the thickness direction through the binder, the double-sided composite reinforced rockwool board of the present disclosure is conducive to increasing the strength of the two surfaces of the rockwool base layer 510 facing outwards along the thickness direction, thereby preventing the corresponding surfaces of the rockwool base layer 510 from being damaged by friction in the process of transportation and construction, and improving the overall service life of the board. Specifically, by respectively attaching the two surfaces of the rockwool base layer 510 along the thickness direction to the reinforced surface layer 520, the rockwool base layer 510 can be prevented from being damaged due to friction and collision, and especially, the rockwool debris generated by the rockwool base layer 510 can be reduced, thereby making the board more flat and cleaner.

For example, the 90° peel strength between either of the two reinforcing surfaces 520 and the rockwool base layer 510 may be in the range of 4 N/75 mm~30 N/75 mm. Here, the 90° peel strength may be used to measure the bonding effect between the rockwool base layer 510 and either of the two reinforcing surfaces 520. By setting the 90° peel strength of the reinforcing surface layer 520 and the rockwool base layer 510 in the range of 4 N/75 mm~30 N/75 mm, the robustness of the connection structure between the reinforcing surface layer 520 and the rockwool base layer 510 is ensured.

As shown in FIG. 8, the measurement principle of the 90° peel strength of the reinforced surface layer 520 and the rockwool base layer 510 is as follows: an angle between the reinforced surface layer 520 and the rockwool base layer 510 is 90°, the tensile force F is applied at a uniform speed, and the average tensile bonding strength is taken as the peel strength.

The reinforced surface layer 520 according to the present disclosure may be configured as at least one of glass fiber woven fabric, coated non-woven felt, and non-coated non-woven felt. That is, the reinforced surface layer 520 may be selected from any one of the glass fiber woven fabric, the coated non-woven felt, and the non-coated non-woven felt. The reinforced surface layer 520 may also be a composite structure of two or more selected from the glass fiber woven fabric, the coated non-woven felt, and the non-coated non-woven felt. The reinforced surface layer 520 may be superimposed and compounded along the thickness direction when the reinforced surface layer is a composite structure of two or more selected from the glass fiber woven fabric, the coated non-woven felt and the non-coated non-woven felt.

In one example of the present disclosure, the reinforced surface layer 520 may be configured as glass fiber woven fabric. The glass fiber woven fabric here may be knitted plain cloth with a gram weight ranging from 40 g/m² to 1200 g/m². The glass fiber woven fabric here may also be mesh cloth with a gram weight ranging from 40 g/m² to 200 g/m².

In another example of the present disclosure, the reinforced surface layer 520 may be configured as coated non-woven felt.

The coated non-woven felt here may have a gram weight ranging from 100 g/m² to 400 g/m². For example, the gram weight of the coated non-woven felt may be in the range of one of any values such as 100 g/m², 200 g/m², 300 g/m², 400 g/m², etc.

The coated non-woven felt may have a thickness ranging from 0.1 mm to 1.5 mm. For example, the thickness of the coated non-woven felt may be in the range of one of any values such as 0.1 mm, 0.5 mm, 1.0 mm, 1.5 mm, etc.

The coated non-woven felt may have a tensile strength ranging from 100 N/50 mm to 1000 N/50 mm. For example, the tensile strength of the coated non-woven felt may be one of any values such as 100 N/50 mm, 300 N/50 mm, 500 N/50 mm, 700 N/50 mm, 1000 N/50 mm, etc.

The coated non-woven felt may have a calorific value ranging from 1 MJ/kg to 10 MJ/kg. For example, the calorific value of the coated non-woven felt may be one of any values such as 1 MJ/kg, 3 MJ/kg, 5 MJ/kg, 7 MJ/kg, 10 MJ/kg, etc.

The coated non-woven felt may have an air permeability under 100 Pa pressure ranging from 100 L/m²·s to 10000 L/m²·s. For example, the air permeability of the coated non-woven felt under 100 Pa pressure may be one of any values such as 100 L/m²·s, 300 L/m²·s, 500 L/m²·s, 700 L/m²·s, 10000 L/m²·s, etc.

The coated non-woven felt after aging may have a strength retention rate ranging from 50% to 100%. For example, the strength retention rate of the coated non-woven felt after aging may be one of any values such as 50%, 60%, 70%, 80%, 90%, 100%, etc.

In the example of the present disclosure where the reinforced surface layer 520 is configured as the coated non-woven felt, the coating of the coated non-woven felt may be made of a resin and a filler. Wherein, the resin may be an acrylic resin. The filler may be made of calcium carbonate, cement, sand and a color master.

Further, the coated non-woven felt may be configured as coated non-woven glass fiber felt.

In yet another example of the present disclosure, the reinforced surface layer 520 may be configured as non-coated non-woven felt.

The non-coated non-woven felt here may have a gram weight ranging from 30 g/m² to 100 g/m². For example, the gram weight of the non-coated non-woven felt may be one of any values such as 30 g/m², 50 g/m², 70 g/m², 90 g/m², 100 g/m², etc.

The non-coated non-woven felt may have a thickness ranging from 0.1 mm to 1.0 mm. For example, the thickness of the non-coated non-woven felt may be one of any values such as 0.1 mm, 0.5 mm, 0.8 mm, 1.0 mm, etc.

The non-coated non-woven felt may have a tensile strength ranging from 100 N/50 mm to 1000 N/50 mm. For example, the tensile strength of the non-coated non-woven felt may be one of any values such as 100 N/50 mm, 300 N/50 mm, 500 N/50 mm, 700 N/50 mm, 1000 N/50 mm, etc.

The non-coated non-woven felt may have a calorific value ranging from 1 MJ/kg to 10 MJ/kg. For example, the calorific value of the non-coated non-woven felt may be one of any values such as 1 MJ/kg, 3 MJ/kg, 5 MJ/kg, 7 MJ/kg, 10 MJ/kg, etc.

The non-coated non-woven felt after aging may have a strength retention rate ranging from 50% to 100%. For example, the strength retention rate of the non-coated non-woven felt after aging may be one of any values such as 50%, 60%, 70%, 80%, 90%, 100%, etc.

Further, the non-coated non-woven felt may be configured as a non-coated non-woven glass fiber felt.

In the example of the present disclosure where the reinforced surface layer 520 is configured as the non-coated non-woven felt, the non-coated non-woven felt may be made of glass fiber and urea-formaldehyde resin.

In the example of the present disclosure where the reinforced surface layer 520 is configured as the non-coated non-woven felt, the non-coated non-woven felt may also be made of glass fiber and acrylic resin.

The double-sided composite reinforced rockwool board according to the present disclosure may have a density ranging from 60 kg/m³ to 220 kg/m³. For example, the density of the double-sided composite reinforced rockwool board here may be one of any values such as 60 kg/m³, 80 kg/m³, 120 kg/m³, 180 kg/m³, 220 kg/m³, etc.

In an example, the resin bonding the rockwool base layer 510 and either of the two reinforced surface layers 520 may have a weight ranging from 1 g/m² to 100 g/m².

Further, the weight of the resin bonding the rockwool base layer 510 and either of the two reinforced surface layers 520 may range from not less than 5 g/m² to less than 10 g/m². The weight of the resin bonding the rockwool base layer 510 and either of the two reinforced surface layers 520 may also range from greater than 10 g/m² to less than 20 g/m².

In another example, the resin bonding the rockwool base layer 510 and the two reinforced surface layers 520 may have a total weight ranging from 1 g/m² to 100 g/m².

Further, the total weight of the resin bonding the rockwool base layer 510 and the two reinforced surface layers 520 may range from not less than 5 g/m² to less than 10 g/m². The total weight of the resin bonding the rockwool base layer 510 and the two reinforced surface layers 520 may also range from greater than 10 g/m² to less than 20 g/m².

For example, the binder is made of at least one of phenolic resin, epoxy resin, polyurethane, acrylic resin, sugar-based resin, urea-formaldehyde resin, and polyvinyl alcohol resin. The binder here is used to bond the reinforced surface layer 520 to the rockwool base layer 510. The binder used in the production of the rockwool base layer 510 may also be the same as the binder coated on the reinforced surface layer 520.

The rockwool base layer 510 according to the present disclosure may be configured as a structure pressed by using a pleating process. The pleating ratio may range from 1.0 to 4.0.

Optionally, the rockwool base layer 510 has a resin. That is, the rockwool base layer 510 itself contains a resin. The resin content of the rockwool base layer 510 may range from 1.0% to 5.0%.

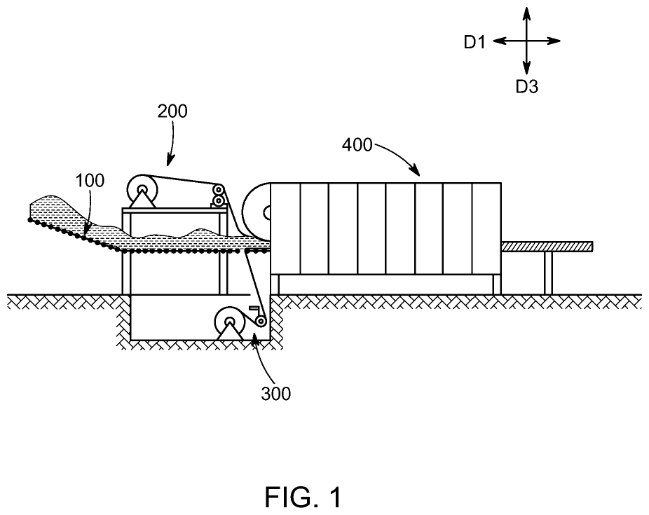

Referring to FIGS. 1 to 7, the present disclosure further provides a production equipment for the double-sided composite reinforced rockwool board. The production equipment is used for producing the double-sided composite reinforced rockwool board. The production equipment for the double-sided composite reinforced rockwool board according to the present disclosure may include a transfer device 100, a first composite device 200 and a second composite device 300. The transfer device 100 is used to convey rockwool base body. The rockwool base body here may be pressed by using the pleating process. The first composite device 200 is disposed corresponding to an upper portion of the rockwool base body located on the transfer device 100. The first composite device 200 is used to apply glue to the reinforced surface layer 520 above the rockwool base body and convey the reinforced surface layer 520 to the upper portion of the rockwool base body such that the reinforced surface layer 520 is attached to the upper portion of the rockwool base body. The second composite device 300 is disposed corresponding to a lower portion of the rockwool base body located on the transfer device 100. The second composite device 300 is used to apply glue to the reinforced surface layer 520 below the rockwool base body and convey the reinforced surface layer 520 to the lower portion of the rockwool base body such that the reinforced surface layer 520 is attached to the lower portion of the rockwool base body.

According to the production equipment for the double-sided composite reinforced rockwool board of the present disclosure, the rockwool base body is conveyed through the transfer device 100; the reinforced surface layer 520 located above the rockwool base body is applied with glue and conveyed to the upper portion of the rockwool base body by the first composite device 200, such that the reinforced surface layer 520 above the rockwool base body may be attached to the upper portion of the rockwool base body; the reinforced surface layer 520 located below the rockwool base body is applied with glue and conveyed to the lower portion of the rockwool base body by the second composite device 300, such that the reinforced surface layer 520 below the rockwool base body may be attached to the lower portion of the rockwool base body. By adopting the production equipment for the double-sided composite reinforced rockwool board of the present disclosure, the upper and lower portions of the rockwool base body may be attached to the reinforced surface layer 520 respectively, and the double-sided composite reinforced rockwool board may thereby be prepared; since the first composite device 200 and the second composite device 300 may operate simultaneously, it helps to improve the production efficiency of the double-sided composite reinforced rockwool board.

For example, the transfer device 100 may be configured as a conveyer belt, a conveyer chain plate, and a conveyer roller, and the like.

The first composite device 200 and the second composite device 300 according to the present disclosure may both comprise an unwinding assembly and a gluing assembly. The unwinding assembly is used to unwind the rolled reinforced surface layer 520. The gluing assembly is located between the unwinding assembly and the transfer device 100. The gluing assembly is used to apply a binder to the unwound reinforced surface layer 520.

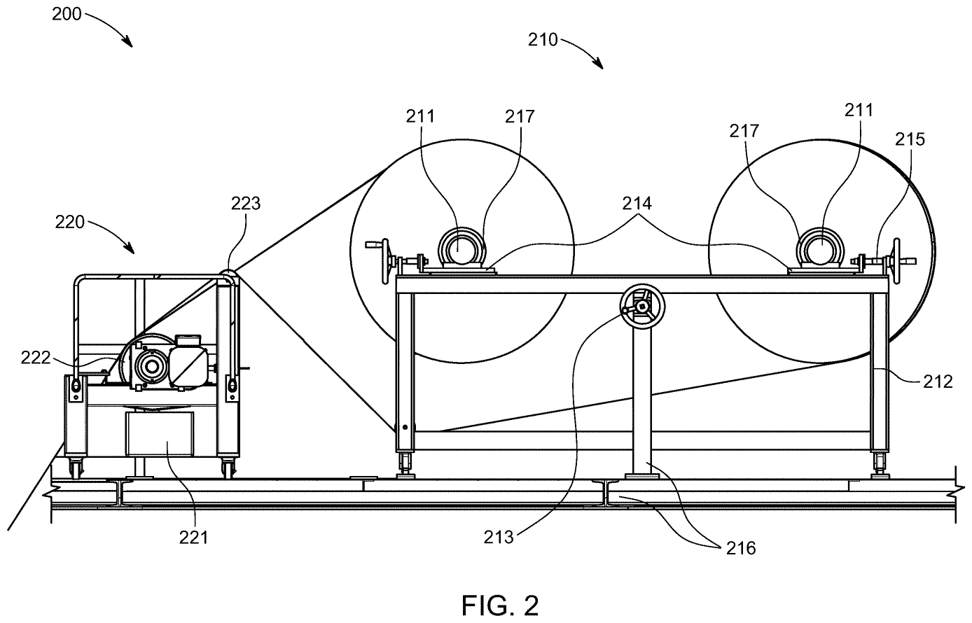

Referring to FIG. 2, for example, the first composite device 200 may include a first unwinding assembly 210 and a first gluing assembly 220.

The first unwinding assembly 210 may include a first mandrel 211, a first transverse movable support 212, a first transverse adjusting member 213, a first longitudinal movable support 214, a first longitudinal adjusting member 215, a first frame 216 and a first brake member 217. The first mandrel 211 is rotationally mounted to one of the first transverse movable support 212 and the first longitudinal movable support 214 about its own axis. The other of the first transverse movable support 212 and the first longitudinal movable support 214 is connected to the first frame 216. The first transverse movable support 212 and the first longitudinal movable support 214 are connected to each other. The first transverse movable support 212 may move relative to the first frame 216 along the transverse direction D2 to change the position of the first mandrel 211 along the transverse direction D2. The first longitudinal movable support 214 may move relative to the first frame 216 along the longitudinal direction D1 to change the position of the first mandrel 211 along the longitudinal direction D1. The first longitudinal adjusting members 215 are provided with two groups. The two groups of the first longitudinal adjusting members 215 are arranged respectively and correspondingly at both ends of the first mandrel 211 along the axial direction. The first longitudinal adjustment member 215 is adapted to be operated to adjust the position of the end portion of the first mandrel 211 along the axial direction in the longitudinal direction D1. The first transverse adjusting member 213 is connected between the first frame 216 and the other of the first transverse movable support 212 and the first longitudinal movable support 214. The first transverse adjusting member 213 is adapted to be operated to adjust the position of the other of the first transverse movable support 212 and the first longitudinal movable support 214 in the transverse direction D2, thereby changing the position of the first mandrel 211 in the transverse direction D2. The first brake member 217 is connected to the first mandrel 211 and adapted to be operated to adjust the damping force applied to the first mandrel 211. The longitudinal direction D1 here is perpendicular to the transverse direction D2. The axis of the first mandrel 211 is roughly parallel to the transverse direction D2.

The first gluing assembly 220 may include a first glue groove 221, a first glue roller 222, and a first guide roller 223. The first glue groove 221 is used to accommodate the binder. The first glue roller 222 is located above the first glue groove 221. The first glue roller 222 is at least partially located inside the first glue groove 221 and is rotationally disposed about its own axis relative to the first glue groove 221. The first glue roller 222 is roughly parallel to the first mandrel 211. The first glue roller 222 is used to adhere the binder in the first glue groove 221 and apply the binder to the reinforced surface layer 520. The first guide roller 223 is rotationally disposed about its own axis relative to the first glue groove 221. The first glue roller 222 and the first guide roller 223 are used to contact two surfaces with different orientations of the reinforced surface layer 520, respectively. The number and position of the first guide rollers 223 may be determined according to actual production needs.

In the example shown in FIG. 2, the first transverse movable support 212 is movably mounted to the upper portion of the first frame 216 along the transverse direction D2. The first longitudinal movable support 214 is movably mounted to the upper portion of the first transverse movable support 212 along the longitudinal direction D1. The first longitudinal adjusting member 215 is installed between the first longitudinal movable support 214 and the first transverse movable support 212. The first longitudinal adjusting member 215 may include a screw extending along the longitudinal direction D1. The screw is threaded to at least one of the first transverse movable support 212 and the first longitudinal movable support 214. The first longitudinal movable support 214 may be moved along the longitudinal direction D1 relative to the first transverse movable support 212 by rotating the screw. The first transverse adjusting member 213 may include a screw extending along the transverse direction D2. The screw is threaded to at least one of the first transverse movable support 212 and the first frame 216. The first transverse movable support 212 may be moved along the transverse direction D2 relative to the first frame 216 by rotating the screw. Both the first longitudinal adjusting member 215 and the first transverse adjusting member 213 may also include a handwheel connected to the screw. The handwheel is used to be operated to rotate the screw.

The first gluing assembly 220 provided according to an example of the present disclosure may include a pair of first guide rollers 223. The pair of first guide rollers 223 are respectively located on both sides of the first glue roller 222 along a conveying direction of the reinforced surface layer 520 to limit a contact area between the first glue roller 222 and the reinforced surface layer 520.

Further, the first guide roller 223 is movably disposed along a vertical direction D3 relative to the first glue roller 222 to adjust a contact area between the guide roller and the reinforced surface layer 520. The first gluing assembly 220 may include a fastener for securing the position of the guide roller along the vertical direction D3. The fastener here may be a bolt.

The first gluing assembly 220 provided according to another example of the present disclosure may include a glue groove, an upper glue roller and a lower glue roller. The lower glue roller is at least partially located inside the glue groove and rotationally disposed about its own axis relative to the glue groove. The upper glue roller is located above the lower glue roller. The upper glue roller is in contact with or close to the surface of the lower glue roller. The lower glue roller is used to adhere the binder in the glue groove to the upper glue roller. The upper glue roller is used to apply the binder to the reinforced surface layer 520.

Further, the upper and lower glue rollers are movably disposed relative to each other along the vertical direction D3. In this way, the spacing between the upper and lower glue rollers may be adjusted so as to regulate the thickness of the binder attached to the upper glue roller.

Referring to FIG. 2, for example, the first unwinding assembly 210 may include at least two first mandrels 211. The at least two first mandrels 211 are arranged at intervals along the conveying direction of the reinforced surface layer 520. When one of the at least two first mandrels 211 is in use, the remaining one of at least two first mandrels 211 may serve as a backup. For example, new roll material may be installed on the remaining spare first mandrel 211 before the roll material on the first mandrel 211 in use is not used up.

For another example, the first unwinding assemblies 210 may be provided with at least two groups. At least two groups of the first unwinding assemblies 210 may be arranged along the transverse direction D2, such that the first unwinding assemblies 210 of each group may be simultaneously unwound, thereby splicing and forming a reinforced surface layer 520 on the upper portion of the rockwool base layer 510. At least two groups of the first unwinding assemblies 210 may also be arranged in sequence along the longitudinal direction D1. When one group of the at least two groups of the first unwinding assemblies 210 are unwound, the remaining first unwinding assemblies 210 may serve as a backup. At least two groups of the first unwinding assemblies 210 may also be arranged along the transverse direction D2 and longitudinal direction D1, respectively.

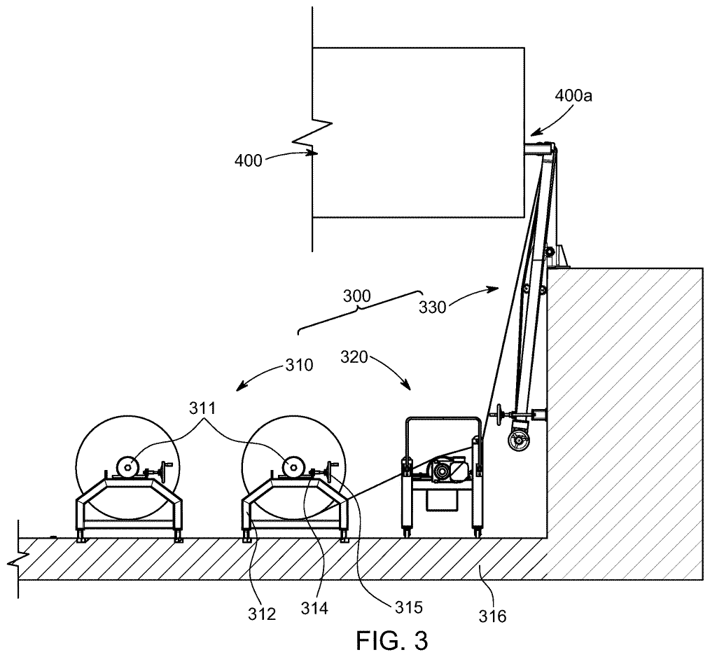

Referring to FIG. 3, for example, the second composite device 300 may include a second unwinding assembly 310 and a second gluing assembly 320.

Wherein, the second unwinding assembly 310 may include a second mandrel 311, a second transverse movable support 312, a second longitudinal movable support 314, a second longitudinal adjusting member 315, a second frame 316, and a second brake member (not marked). The second mandrel 311 is rotationally mounted about its own axis to one of the second transverse movable support 312 and the second longitudinal movable support 314. The other of the second transverse movable support 312 and the second longitudinal movable support 314 is connected to the second frame 316. The second transverse movable support 312 and the second longitudinal movable support 314 are connected to each other. The second transverse movable support 312 may move relative to the second frame 316 along the transverse direction D2 to change the position of the second mandrel 311 along the transverse direction D2. The second longitudinal movable support 314 may move relative to the second frame 316 along the longitudinal direction D1 to change the position of the second mandrel 311 along the longitudinal direction D1. The second longitudinal adjusting members 315 are provided with two groups. The two groups of the second longitudinal adjusting members 315 are arranged respectively at both ends of the second mandrel 311 along the axial direction. The second longitudinal adjusting member 315 is adapted to be operated to adjust the position of the end portion of the second mandrel 311 along the axial direction in the longitudinal direction D1. The second brake member is connected to the second mandrel 311 and adapted to be operated to adjust the damping force on the second mandrel 311. The axis of the second mandrel 311 is roughly parallel to the transverse direction D2.

The second gluing assembly 320 may include a second glue groove 321, a second glue roller 322, and a second guide roller 323. The second glue groove 321 is used to accommodate the binder. The second glue roller 322 is located in the upper portion of the second glue groove 321. The second glue roller 322 is at least partially located inside the second glue groove 321 and rotationally arranged about its own axis relative to the second glue roller 322. The second glue roller 322 is roughly parallel to the second mandrel 311. The second glue roller 322 is used to adhere the binder in the second glue groove 321 and apply the binder to the reinforced surface layer 520. The second guide roller 323 is rotationally disposed about its own axis relative to the second glue groove 321. The second glue roller 322 and the second guide roller 323 are used to contact two surfaces with different orientations of the reinforced surface layer 520, respectively. The number and position of the second guide rollers 323 may be determined according to actual production needs.

In the example shown in FIG. 3, the second transverse movable support 312 is movably mounted to the upper portion of the second frame 316 along the transverse direction D2. The second longitudinal movable support 314 is movably mounted to the upper portion of the second transverse movable support 312 along the longitudinal direction D1. The second longitudinal adjusting member 315 is installed between the second longitudinal movable support 314 and the second transverse movable support 312. The second longitudinal adjusting member 315 may include a screw extending along the longitudinal direction D1. The screw is threaded to at least one of the second transverse movable support 312 and the second longitudinal movable support 314. The second longitudinal movable support 314 may be moved along the longitudinal direction D1 relative to the second transverse movable support 312 by rotating the screw. The second longitudinal adjusting member 315 may also include a handwheel connected to a screw. The handwheel is used to be operated to rotate the screw. The second frame 316 may be configured as a foundation pit. Here, the foundation pit is opened on the floor of a production workshop.

The second gluing assembly 320 provided according to an example of the present disclosure may include a pair of second guide rollers 323. The pair of second guide rollers 323 are respectively located on both sides of the second glue roller 322 along a conveying direction of the reinforced surface layer 520 to limit a contact area between the second glue roller 322 and the reinforced surface layer 520.

Further, the second guide roller 323 is movably disposed along a vertical direction D3 relative to the second glue roller 322 to adjust a contact area between the guide roller and the reinforced surface layer 520. The second gluing assembly 320 may include a fastener for securing the position of the guide roller along the vertical position D3. The fastener here may be a bolt.

The second gluing assembly 320 provided according to another example of the present disclosure may include a glue groove, an upper glue roller and a lower glue roller. The lower glue roller is at least partially located inside the glue groove and rotationally disposed about its own axis relative to the glue groove. The upper glue roller is located above the lower glue roller. The upper glue roller is in contact with or close to the surface of the lower glue roller. The lower glue roller is used to adhere the binder in the glue groove to the upper glue roller. The upper glue roller is used to apply the binder to the reinforced surface layer 520.

Further, the upper and lower glue rollers are movably disposed relative to each other along the vertical direction D3. In this way, the spacing between the upper and lower glue rollers may be adjusted, so that the thickness of the binder attached to the upper glue roller may be adjusted.

Referring to FIG. 3, for example, the second unwinding assembly 310 may include at least two second mandrels 311. The at least two second mandrels 311 are dis[osed at intervals along the conveying direction of the reinforced surface layer 520. When one of the at least two second mandrels 311 is in use, the remaining one of at least two second mandrels 311 may serve as a backup. For example, new roll material may be installed on the remaining spare second mandrel 311 before the roll material on the second mandrel 311 in use is not used up.

For another example, the second unwinding assemblies 310 may be provided with at least two groups. At least two groups of the second winding assemblies 310 may be arranged along the transverse direction D2, such that the second unwinding assemblies 310 of each group may be simultaneously unwound, thereby splicing and forming a reinforced surface layer 520 on the upper portion of the rockwool base layer 510. At least two groups of the second unwinding assemblies 310 may also be arranged in sequence along the longitudinal direction D1. When one group of the at least two groups of the second unwinding assemblies 310 are unwound, the remaining second unwinding assemblies 310 may serve as a backup. At least two groups of the second unwinding assemblies 310 may also be arranged along the transverse direction D2 and longitudinal direction D1, respectively.

Referring to FIG. 1 and FIG. 3, moreover, the production equipment for the double-sided composite reinforced rockwool board may also include a curing furnace 400. The second unwinding assembly 310 and the second gluing assembly 320 both are located below the curing furnace 400. The second composite device 300 may also include a traction assembly 330. One end of the traction assembly 330 is arranged corresponding to an inlet 400a of the curing furnace 400 such that the reinforced surface layer 520 coated with the binder is close to the lower surface of the rockwool base body. The other end of the traction assembly 330 is arranged corresponding to the gluing assembly to undertake the reinforced surface layer 520 coated with the binder. By providing the traction assembly 330, it is possible to guide the reinforced surface layer 520 located below to the lower portion of the rockwool base body so that the reinforced surface layer 520 is attached to the lower portion of the rockwool base body. Since the second unwinding assembly 310 and the second gluing assembly 320 both are located in the foundation pit below the curing furnace 400, it improves the space utilization rate, makes the overall layout of the production equipment more compact, and facilitates the management and maintenance of the production equipment.

Referring to FIGS. 3 to 7, for example, the traction assembly 330 may include a traction support 331, two synchronization shafts 332, two pairs of sprockets 333, a pair of chains 334, and a traction member 335. The synchronization shaft 332 is rotationally connected to the traction support 331 about its own axis. The two synchronization shafts 332 are parallel to each other and cross the conveying direction of the rockwool base body. The two synchronization shafts 332 are disposed at intervals along the vertical direction D3. One pair of sprockets 333 of the two pairs of sprockets 333 are respectively disposed on two ends of one synchronization shaft 332 of the two synchronization shafts 332, and the other pair of sprockets 333 of the two pairs of sprockets 333 are respectively disposed on two ends of the other synchronization shaft 332 of the two synchronization shafts 332. A pair of chains 334 is disposed at intervals along the axial directions of the synchronization shafts 332. The chains 334 are engaged with the sprockets 333 for transmission connection. The engagement herein may be understood as biting or meshing. A pair of chains 334 are respectively provided with the traction member 335. The traction members 335 located in the pair of chain 334 are arranged relative to each other. The traction member 335 is configured to connect to the end portion of the traction rope. The traction rope here may be selected from the rope or cord in the prior art. By rotating the synchronization shaft 332, the two pairs of sprockets 333 may be driven to synchronously rotate through the chain 334. During the movement of chain 334, the traction member 335 moves with the chain 334. When in use, the traction member 335 located on one of chains 334 may be connected to the traction member 335 of the other of chains 334 by the traction rope along the axial direction of the synchronization shaft 332 such that the traction rope is straddled between one pair of chains 334. The traction rope then may be connected to one end of the material roll of the reinforced surface layer 520 by means of affixing tape, staples, etc. Finally, by rotating the synchronization shaft 332, one end of the material roll may be pulled in the direction of the conveying line close to the rockwool base body. In this process, the material roll of the reinforced surface layer 520 is unwound adaptively under the action of the traction force of the traction assembly 330.

In order to facilitate the rotation of the synchronization shaft 332, a synchronization handwheel 337 may be installed at the end portion of the synchronization shaft 332. The synchronization shaft 332 may be rotated by rotating the synchronization handwheel 337.

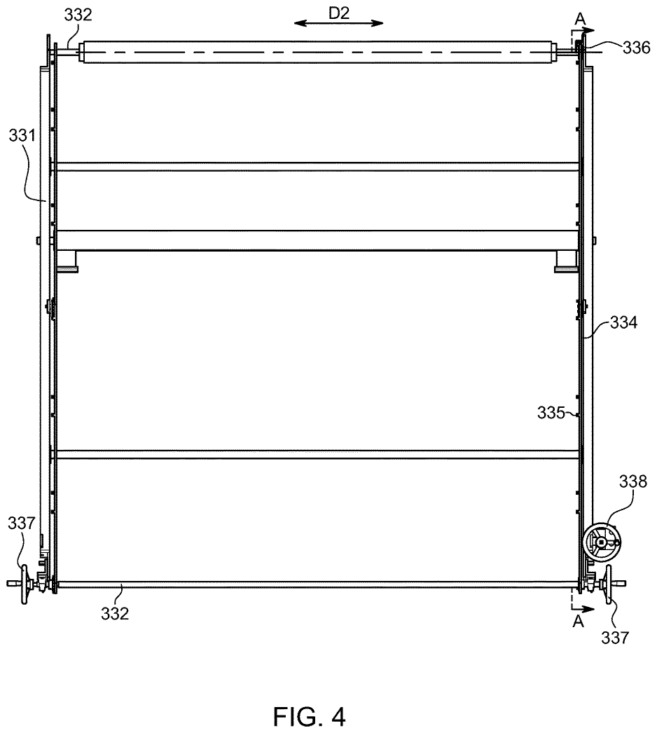

Referring to FIGS. 4 to 7, moreover, the traction assembly 330 may also include a cutting member 336. The cutting member 336 is located at the end portion of the traction support 331 near the inlet 400a of the curing furnace 400. The cutting member 336 has a cutting part 336a for cutting off the traction rope. The cutting part 336a is located in an interval region between the pair of the traction members 335. The cutting member 336 here may be a metal plate with a blade. The cutting part 336a is the blade. The outline shape of the blade may be V shape, arc shape, etc., which can prevent the traction rope from slipping off during the cutting process.

Referring to FIGS. 4 to 6, for example, the cutting member 336 may be a sheet metal member that has been bent at least once, such that the cutting part 336a may be staggered from the traction member 335 along the axial direction of the synchronization shaft 332, thereby avoiding the movement of the traction member 335. In the illustrated example, the cutting member 336 may be roughly configured as a Z-shaped plate member.

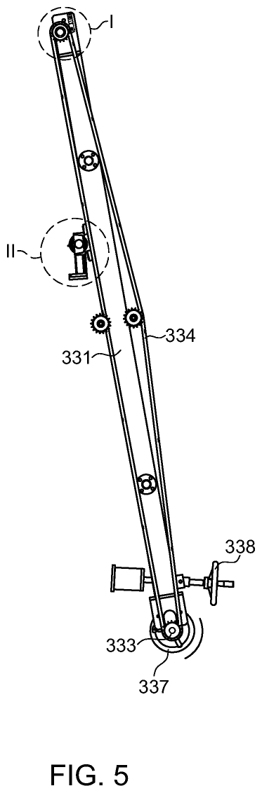

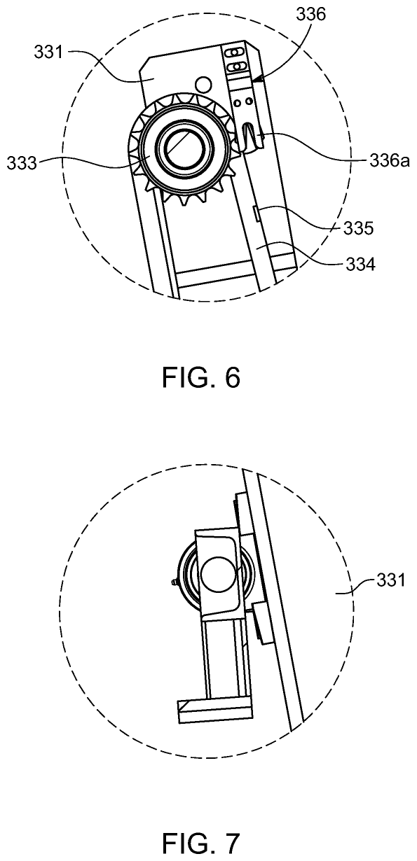

Referring to FIGS. 5 and 6, the middle part of the traction support 331 may be pivotingly disposed relative to the second frame 316 about the pivot axis parallel to the synchronization shaft 332. A lead screw nut assembly may be provided at one end of the traction support 331 along a transmission direction of the chain 334. The lead screw nut assembly here may include a lead screw, a nut and a fastener. The lead screw is threaded to the nut. The nut is mounted on the traction support 331. One end of the lead screw is rotationally installed in the fastener. The fastener is fixedly disposed relative to the second frame 316. For example, in the case that the second frame 316 is configured as the inner wall of the foundation pit, the fastener may be fixed to the inside wall of the foundation pit. The rotation of the lead screw may drive the traction support 331 to rotate around the pivot axis, thereby adjusting the pitch angle of the traction support 331. The end portion of the lead screw away from the fastener may be fixedly connected to an adjusting handwheel 338. The purpose of driving the rotation of the lead screw may be achieved by operating the adjusting handwheel 338 to rotate. The nut here is pivotable about another pivot axis relative to the traction support 331, thereby adapting to the change of the pitch angle of the traction support 331.

Referring to FIGS. 1 to 7, the present disclosure further provides a preparation method of the double-sided composite reinforced rockwool board for the production of the above double-sided composite reinforced rockwool board. The preparation method of the double-sided composite reinforced rockwool board according to the present disclosure comprises the following steps:
S0, after the rockwool fiber is made into fiber and applied with glue, the rockwool fiber is integrated into a primary felt through negative pressure adsorption by using a cotton collecting device and then the felt is evenly distributed on a production line layer by layer via a pendulum, so as to obtain an uncured rockwool base layer 510;
S1, the binder is uniformly applied on the surface of the reinforced surface layer 520;
S2, an online curing and drying process is used to respectively bond online the two reinforced surface layers 520 with two opposite surfaces of the uncured rockwool base layer 510 along the thickness direction, and the bonded reinforced surface layers 520 and the rockwool base layer 510 pass through the curing furnace 400 and are dried, cured and molded under the action of the ventilation air flow and pressurization of a chain plate of the curing furnace 400, so as to obtain the double-sided composite reinforced rockwool board.

According to the preparation method for the double-sided composite reinforced rockwool board of the present disclosure, after a binder is applied to the reinforced surface layer 520, two reinforced surface layers 520 with the binder are respectively bonded to two opposite surfaces of the rockwool base layer 510 along the thickness direction and then the double-sided composite reinforced rockwool board is prepared by curing in the curing furnace 400. By using the preparation method of the double-sided composite reinforced rockwool board of the present disclosure, the double-sided composite reinforced rockwool board may be made, and the production efficiency may be improved.

Optionally, in step S1, the process of applying the binder is one of spraying, coating and film transferring.

Optionally, in step S1, the binder is selected from at least one of phenolic resin, epoxy resin, polyurethane, acrylic resin, sugar-based resin, urea-formaldehyde resin, and polyvinyl alcohol resin.

Optionally, in step S2, the curing furnace 400 has at least two, e.g., four temperature zones. Each temperature zone is successively disposed at a position from the inlet 400a to the outlet of the curing furnace 400. Each temperature zone has a temperature ranging from 180° C. to 300° C. The main purpose of partitioning the curing furnace is to change the direction of curing wind and achieve uniform curing of the product under the curing time is unchanged. In some application scenarios, the maximum temperature of each section of the curing furnace may usually be set at a maximum temperature of 280° C. or even 300° C. The shorter the curing time, the higher the temperature required for the curing furnace.

Unless otherwise defined, the technical and scientific terms used herein have the same meanings as commonly understood by those skilled in the technical field of the present disclosure. The terms used herein are only for describing specific implementation purposes, and are not intended to limit the present disclosure. Terms such as “dispose” and the like appearing herein may mean that one component is directly attached to another component, or that one component is attached to another component through an intermediate component. A feature described in one embodiment herein may be applied to another embodiment alone or in combination with other features, unless the feature is not applicable in the other embodiment or otherwise stated.

The present disclosure has been described through the above-mentioned embodiments, but it should be understood that the above-mentioned embodiments are only for the purpose of illustration and description, and are not intended to limit the present disclosure to the scope of the described embodiments. Those skilled in the art may understand that more variations and modifications may be made according to the teachings of the present disclosure, and these variations and modifications fall within the protection scope claimed by the present disclosure.

1. A double-sided composite reinforced rockwool board, wherein the double-sided composite reinforced rockwool board has a length ranging from 600 mm to 2400 mm, a width ranging from 600 mm to 2400 mm, and a thickness ranging from 20 mm to 200 mm, and the double-sided composite reinforced rockwool board comprises:
a rockwool base layer; and
two reinforced surface layers respectively bonded by a binder to two opposite surfaces of the rockwool base layer along a thickness direction, a 90° peel strength between any one of the two reinforced surface layers and the rockwool base layer ranging from 4 N/75 mm to 30 N/75 mm.

2. The double-sided composite reinforced rockwool board of claim 1, wherein,
each reinforced surface layer is at least one of a glass fiber woven fabric, a coated non-woven felt, and a non-coated non-woven felt.

3. The double-sided composite reinforced rockwool board of claim 1, wherein each reinforced surface layer is a glass fiber woven fabric, and wherein the glass fiber woven fabric is one of a knitted plain cloth with a gram weight ranging from 40 g/m² to 1200 g/m²; and a mesh cloth with a gram weight ranging from 40 g/m² to 200 g/m².

4. The double-sided composite reinforced rockwool board of claim 1, wherein each reinforced surface layer is a coated non-woven felt, and wherein, the coated non-woven felt has at least one of a gram weight ranging from 100 g/m² to 400 g/m²; a thickness ranging from 0.1 mm to 1.5 mm; a tensile strength ranging from 100 N/50 mm to 1000 N/50 mm; a calorific value ranging from 1 MJ/kg to 10 MJ/kg; an air permeability under 100 Pa pressure ranging from 100 L/m²·s to 10000 L/m²·s; and a strength retention rate after aging ranging from 50% to 100%.

5. The double-sided composite reinforced rockwool board of claim 1, wherein each reinforced surface layer is a coated non-woven felt comprising a coating made of a resin and a filler; wherein the resin is an acrylic resin, and the filler includes at least one of calcium carbonate, cement, sand, and color master.

6. The double-sided composite reinforced rockwool board of claim 2, wherein the coated non-woven felt is a coated non-woven glass fiber felt.

7. The double-sided composite reinforced rockwool board of claim 1, wherein each reinforced surface layer is a non-coated non-woven felt, and wherein; the non-coated non-woven felt has at least one of a gram weight ranging from 30 g/m² to 100 g/m²; a thickness ranging from 0.1 mm to 1.0 mm; a tensile strength ranging from 100 N/50 mm to 1000 N/50 mm; a calorific value ranging from 1 MJ/kg to 10 MJ/kg; and a strength retention rate after aging ranging from 50% to 100%.

8. The double-sided composite reinforced rockwool board of claim 2, wherein the non-coated non-woven felt is made of glass fiber and at least one of a urea-formaldehyde resin and an acrylic resin.

9. The double-sided composite reinforced rockwool board of claim 2, wherein the non-coated non-woven felt is a non-coated non-woven glass fiber felt.

10. The double-sided composite reinforced rockwool board of claim 1, wherein the double-sided composite reinforced rockwool board has a density ranging from 60 kg/m³ to 220 kg/m³.

11. The double-sided composite reinforced rockwool board of claim 1, wherein a resin bonding the rockwool base layer and at least one of the two reinforced surface layers has a weight ranging from 1 g/m² to 100 g/m².

12. The double-sided composite reinforced rockwool board of claim 1, wherein the binder is made of at least one of a phenolic resin, an epoxy resin, a polyurethane, an acrylic resin, a sugar-based resin, a urea-formaldehyde resin, and a polyvinyl alcohol resin.

13-14. (canceled)

15. A production equipment for producing a double-sided composite reinforced rockwool board having a length ranging from 600 mm to 2400 mm, a width ranging from 600 mm to 2400 mm, and a thickness ranging from 20 mm to 200 mm, and comprising a rockwool base layer, a first reinforced surface layer, and a second reinforced surface layer, wherein the reinforced surface layers are respectively bonded by a binder to two opposite surfaces of the rockwool base layer along a thickness direction, wherein a 90° peel strength between any one of the two reinforced surface layers and the rockwool base layer ranges from 4 N/75 mm to 30 N/75 mm, wherein the production equipment for the double-sided composite reinforced rockwool board comprises:
a transfer device for conveying a rockwool base body;
a first composite device arranged corresponding to an upper portion of the rockwool base body located on the transfer device, and configured to apply glue to the first reinforced surface layer above the rockwool base body and convey the first reinforced surface layer to the upper portion of the rockwool base body such that the first reinforced surface layer is attached to the upper portion of the rockwool base body; and
a second composite device arranged corresponding to a lower portion of the rockwool base body located on the transfer device, and configured to apply glue to the second reinforced surface layer below the rockwool base body and convey the second reinforced surface layer to the lower portion of the rockwool base body such that the second reinforced surface layer is attached to the lower portion of the rockwool base body.

16. The production equipment for the double-sided composite reinforced rockwool board of claim 15, wherein the first composite device and the second composite device both comprise:
an unwinding assembly configured to unwind a rolled reinforced surface layer; and
a gluing assembly configured to apply a binder to the unwound reinforced surface layer.

17. The production equipment for the double-sided composite reinforced rockwool board of claim 16, wherein; the production equipment for double-sided composite reinforced rockwool board further comprises a curing furnace; and wherein the unwinding assembly and the gluing assembly of the second composite device both are located below the curing furnace, and the second composite device also includes a traction assembly, one end of which is arranged corresponding to an inlet of the curing furnace, such that the second reinforced surface layer coated with the binder is close to a lower surface of the rockwool base body, and the other end of which is arranged corresponding to the gluing assembly to undertake the second reinforced surface layer coated with the binder.

18. The production equipment for the double-sided composite reinforced rockwool board of claim 17, wherein, the traction assembly comprises:
a traction support;
two synchronization shafts rotationally connected to the traction support about their own axes, wherein the two synchronization shafts are parallel to each other and cross a conveying direction of the rockwool base body, and the two synchronization shafts are disposed at intervals along a vertical direction;
two pairs of sprockets, one pair of which are respectively disposed on two ends of one of the two synchronization shafts, and the other pair of which are respectively disposed on two ends of the other of the two synchronization shafts;
a pair of chains disposed at intervals along axial directions of the synchronization shafts and engaged with the sprockets; and
traction members with which the pair of chains are respectively provided, and arranged relative to each other in the pair of chains and used to connect to end portions of a traction rope.

19-28. (canceled)

29. A preparation method for a double-sided composite reinforced rockwool board, having a length ranging from 600 mm to 2400 mm, a width ranging from 600 mm to 2400 mm, and a thickness ranging from 20 mm to 200 mm, and comprising a rockwool base layer, a first reinforced surface layer, and a second reinforced surface layer, wherein the reinforced surface layers are respectively bonded by a binder to two opposite surfaces of the rockwool base layer along a thickness direction, wherein a 90° peel strength between any one of the two reinforced surface layers and the rockwool base layer ranges from 4 N/75 mm to 30 N/75 mm, wherein the preparation method for the double-sided composite reinforced rockwool board comprises:
S0, after making rockwool fiber into fiber and applying glue, integrating the rockwool fiber into a primary felt through negative pressure adsorption by using a cotton collecting device and then evenly distributing the primary felt on a production line layer by layer via a pendulum, so as to obtain an uncured rockwool base layer;
S1, uniformly applying a binder on a surface of the first reinforced surface layer and the second reinforced layer;
S2, respectively bonding online the two reinforced surface layers to two opposite surfaces of the uncured rockwool base layer along a thickness direction by using an online curing and drying process, and the bonded reinforced surface layers and the rockwool base layer passing through a curing furnace, and being dried, cured, and molded under the action of a ventilation air flow and a pressurization of a chain plate of the curing furnace, so as to obtain the double-sided composite reinforced rockwool board.

30. The preparation method for the double-sided composite reinforced rockwool board of claim 29, wherein a process of applying the binder is one of spraying, coating, and film transferring in step S1.

31. The preparation method for the double-sided composite reinforced rockwool board of claim 29, wherein in step S1, the binder is selected from at least one of a phenolic resin, an epoxy resin, a polyurethane, an acrylic resin, a sugar-based resin, a urea-formaldehyde resin, and a polyvinyl alcohol resin.

32. The preparation method for the double-sided composite reinforced rockwool board of claim 29, wherein in step S2, the curing furnace has at least two temperature zones, and each temperature zone is successively disposed at a position from an inlet to an outlet of the curing furnace and has a temperature ranging from 180° C. to 300° C.
